(19) United States
(12) Patent Application Publication
(10) Pub. No.: US 2003/0101432 A1
(43) Pub. Date: May 29, 2003

(54) Method and apparatus for unifying the semantics of functions and classes in a programming language

(76) Inventor: David S. Allison, San Ramon, CA (US)

Correspondence Address: ROSENTHAL & OSHA L.L.P. / SUN, 1221 MCKINNEY, SUITE 2800, HOUSTON, TX, 77010, US

(21) Appl. No.: 09/977,516

(22) Filed: Oct. 12, 2001

(51) Int. Cl. G06F 9/44

(52) U.S. Cl. 717/114; 717/116

(57) ABSTRACT

The present invention provides a method and apparatus for the unification of the semantics of classes and functions in a programming language. The semantic rules follow the pattern of: keyword name(parameters), where keyword is either class or function. Both the function and class bodies contain statements that are executed after the structure is instantiated. In either construct, these statements comprise constructor code. A function also optionally returns a value. In one embodiment, software is written in an interpreted programming language implementing the present invention. The interpreter instantiates a class on the memory heap. The class remains instantiated until the class destructor is called. A function is instantiated on the memory stack. The function remains instantiated until the final line of constructor code is executed. The function is then automatically destroyed.

### BACKGROUND OF THE INVENTION

1. Field of the Invention

This invention relates to the field of object-oriented programming. More specifically, the present invention relates to the unification of the definition of a class and a function in a programming language.

Sun, Sun Microsystems, the Sun logo, Solaris and all Java™-based trademarks and logos are trademarks or registered trademarks of Sun Microsystems, Inc. in the United States and other countries. All SPARC trademarks are used under license and are trademarks of SPARC International, Inc. in the United States and other countries. Products bearing SPARC trademarks are based upon an architecture developed by Sun Microsystems, Inc.

2. Background Art

In a traditional programming language, such as Java™ or C++, the concepts of “functions” and a “classes” are distinct. A function computes some output value based on a set of input arguments. A class is used to define a special type for use by the program. The distinction between functions and classes, as will be further explained below, creates difficulties for programmers.

Before discussing these difficulties, it is instructive to summarize the differences between functions and classes in the context of object-oriented programming.

Object Oriented Programming

Object-oriented programming is a method of creating computer programs by combining certain fundamental building blocks, and creating relationships among and between the building blocks. The building blocks object-oriented programming systems are called “objects.” An object is a programming unit that groups together a data structure (instance variables) and the operations (methods) that can use or affect that data. Thus, an object consists of data and one or more operations or procedures that can be performed on that data. The joining of data and operations into a unitary building block is “encapsulation.” In object-oriented programming, operations that can be performed on the data are referred to as “methods.”

An object can be instructed to perform one of its methods when it receives a “message.”A message is a command or instruction to the object to execute a certain method. It consists of a method selection (name) and arguments that are sent to an object. A message tells the receiving object what to do.

One advantage of object-oriented programming is the way in which methods are invoked. When a message is sent to an object, it is not necessary for the message to instruct the object how to perform a certain method. It is only necessary to request that the object execute the method. This greatly simplifies program development.

Object-oriented programming languages are generally based on one of two schemes for representing general concepts and sharing knowledge. One scheme is known as the “class” scheme. The other scheme is known as the “prototype” scheme. Both the set-based (“class” scheme) and prototype-based object-oriented programming schemes are generally described in Lieberman, “Using Prototypical Objects to implement Shared Behavior in Object-Oriented Systems,” OOPSLA 86 Proceedings, September 1986, pp. 214-223.

In accordance with the embodiments of the present invention, the class-based object-oriented scheme will be described.

Class Scheme

An object that describes behavior is called a “class.” Objects that acquire a behavior and that have states are called “instances.” Thus, in the Java™ language, a class is a particular type of object. In Java™, any object that is not a class object is said to be an instance of its class. In C++, a class is defined as follows:

class X {

| | |
|---|---|
| X (int arg) ; | // constructor |
| // class members | |

}

This structure defines the class to be an encapsulation of a set of members.

Some of the class members are defined as being “special” because they have the same name as the class itself. These members are known as a constructor. A class member can be either a data member, or a variable, or a function, also known as a method.

Two or more classes form a “hierarchy.” Each subclass in the hierarchy may add to or modify the behavior of the object in question and may also add additional states. Inheritance is a fundamental property of the class scheme and allows objects to acquire behavior from other objects.

The inheritance hierarchy is the hierarchy of classes defined by the arrangement of superclasses and subclasses. Except for the root classes, every class has a superclass, and any class may have an unlimited number of subclasses. Each class inherits from those classes above it in the hierarchy. Thus, a superclass has the ability to pass its characteristics (methods and instance variables) onto its subclasses.

An example of a superclass in C++ is:

class X {
public:

int x;
// other members of X

} ;

Then a class derived from the superclass, X, is defined as:

class Y : public X {
public:

// other members of Y

} ;

Y inherits the accessible members of X. In this example, the class Y has a member ‘int x’ inherited from class X.

FIG. 1 is a block diagram that illustrates inheritance. Class 1 (generally indicated by block 101) defines a class of objects that have three methods in common, namely, A, B and C. An object belonging to a class is referred to as an “instance” of that class. An example of an instance of class 1 is block 102. An instance such as instance 102 contains all the methods of its parent class. Block 102 contains methods A, B and C.

As discussed, each class may also have subclasses, which also share all the methods of the class. Subclass 1.1 (indicated by block 103) inherits methods A, B and C and defines an additional method, E. Each subclass can have its own instances, such as, for example, instance 104. Each instance of a subclass includes all the methods of the subclass. For example, instance 104 includes methods A, B, C and E of subclass 1.1.

Object-oriented programming languages that utilize the class/instance/inheritance structure described above implement a set-theoretic approach to sharing knowledge. This approach is used in object-oriented programming languages, such as C++, SmallTalk and Java™.

Functions

A function is a named section of a program that performs a specific task. Some programming languages, such as Java™ and C++, distinguish between a function, which returns a value, and a procedure, which performs some operation but does not return a value. Most programming languages come with a prewritten set of functions that are kept in a library.

A function contains a sequence of instructions and associated variables for performing a particular task. Most languages allow arguments to be passed to the function. Function code is executed from multiple places within software, even from within the function itself. When a function calls itself from within its own body, the function is a recursive function. In C++, a function is defined as follows:

int Z (int arg1, int arg2) {

// statement

}

This code block defines a function called “Z” that returns an integer and takes two integer parameters.

Differences Between Classes and Functions

Unlike a class, a function body can contain only variable declarations and statements. No other functions can be defined inside the body. Also, a function cannot inherit from another function or class. These limitations inhibit the use of functions in programming design. For example, object-oriented techniques seek to create known and predictable objects that can be used and re-used in the same or different programs. Since functions, which are one of the building blocks of objects, are limited, the use of functions are correspondingly limited. With less powerful functions many programmers revert to ad-hoc solutions to problems.

### SUMMARY OF THE INVENTION

The present invention provides a method and apparatus for the unification of the semantics of classes and functions in a programming language. In one embodiment, the semantic rules follow the pattern of:

keyword name(parameters)
{

// Constructor Code

}

Keyword may be either “class” or “function”. “Name” is the field in which the name of the function or class is designated. Both the function and class bodies contain statements that are executed after the structure is instantiated. In either construct, the statements in the body comprise constructor code. A function also optionally returns a value.

In one embodiment, an interpreted programming language is used to create computer programs that use the unified semantic rules of the present invention. When a class is instantiated, an interpreter allocates an appropriate amount of space on a memory heap. The class remains instantiated until the class destructor is called. When a function is instantiated, the interpreter places the function on a memory stack. The function remains instantiated until the final line of constructor code is executed. The function is then automatically destroyed.

### BRIEF DESCRIPTION OF THE DRAWINGS

FIG. 1 is a diagram illustrating the concept of class inheritance.

FIG. 2A is a diagram illustrating an embodiment of the present invention in which a class object is instantiated.

FIG. 2B is a diagram illustrating an embodiment of the present invention in which a function object is instantiated.

FIG. 3 is a diagram illustrating an embodiment of the present invention.

FIG. 4 is a diagram of a general purpose computer.

FIG. 5 is an illustration of an embodiment of the present invention.

FIG. 6 is an illustration of another embodiment of the present invention.

FIG. 7 is an illustration of still another embodiment of the present invention.

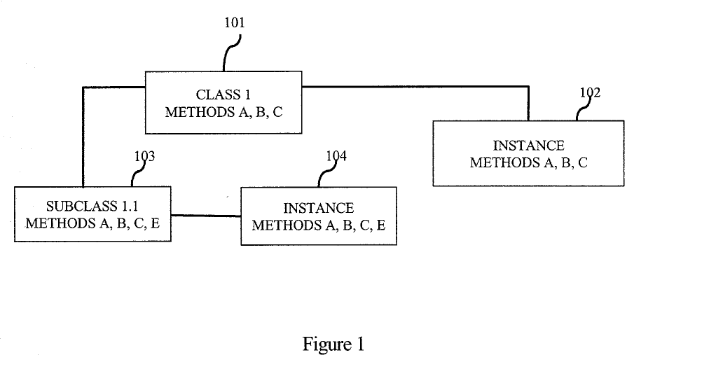

### DETAILED DESCRIPTION OF THE INVENTION

The present invention is directed to the unification of the semantics of classes and functions in a programming language. In the following description, numerous specific details are set forth to provide a more thorough description of embodiments of the invention. It is apparent, however, to one skilled in the art, that the invention may be practiced without these specific details. In other instances, well known features have not been described in detail so as not to obscure the invention.

Unified Semantics

In accordance with one or more embodiments of the present invention, the semantic rules follow the pattern of:

keyword name(parameters)
{

// Constructor Code

}

Keyword may be either “class” or “function”. “Name” is the field in which the name of the function or class is designated. Both the function and class bodies contain statements that are executed after the structure is instantiated. In either construct, the statements in the body comprise constructor code. A function also optionally returns a value.

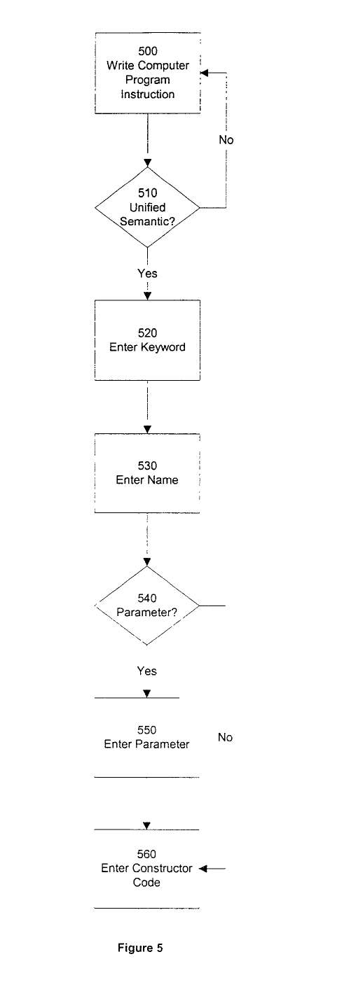

FIG. 5 shows illustrates unified semantics according to one embodiment of the present invention. In block 500, a computer programmer begins to write a computer program instruction. In decision block 510 a determination is made as to whether a statement utilizing the unified semantic rules is to be written. If not, then the programmer writes the statement and begins the next program instruction at block 500 and the process repeats. If, however, the unified semantic rules are to be used at block 510, then in block 520 a keyword is entered. In block 530, the name of the object is entered. In decision block 540, a determination is made as to whether the object takes one or more parameters. If yes, then in block 550, the parameters are entered. If not, or after the parameters are entered, then in block 560, constructor code (i.e., the body) is entered.

Constructor

In accordance with one or more embodiments of the present invention, a class constructor comprises a series of statements defined within the class body. This code is executed when the instance is created. An example of a class definition in accordance with one or more embodiments of the present invention is as follows:

class x (arg1) {

// constructor code
// class members

}

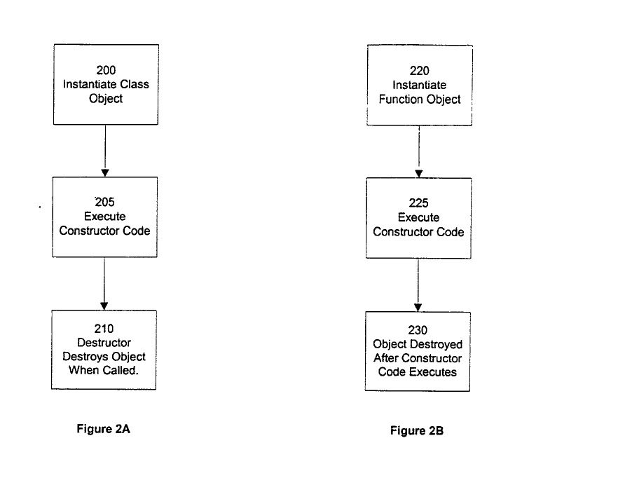

The use of class or function construction code can best be understood in view of diagrams. FIG. 2A illustrates the use of a class in accordance with an embodiment of the present invention. In block 200, a class-type object is instantiated. In block 205, any constructor code in the body of the class is executed. As is well known to those of skill in the art, a constructor may or may not contain user-defined code. In this case, the algorithm simply instantiates the object in block 200 and continues. A class-type object remains instantiated until it is destroyed by a destructor or similar function which may act to remove the function from the system. Thus, in block 210 the object is destroyed when a destructor is called.

FIG. 2B illustrates the use of a function-type object in accordance with an embodiment of the present invention. In block 220 a function-type object is instantiated. In block 225, any constructor code in the body of the class is executed. Function constructor code comprises the code block within the body of the function. In one embodiment of the present invention, the function returns a result. In another embodiment of the present invention, the function executes a block of code but does not return a result. In block 230, the function-type object is destroyed after the constructor code completes execution.

Interpreted Programming Language

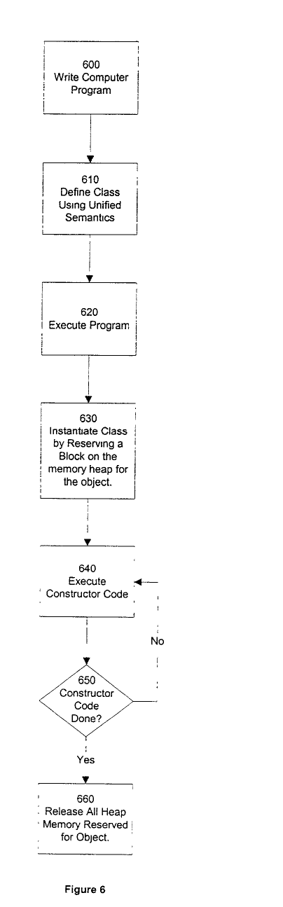

In one embodiment, software is written in an interpreted programming language implementing the present invention. The interpreter instantiates a class on a memory heap. The class remains instantiated until the class destructor is called. FIG. 6 shows this embodiment of the present invention. In block 600, a computer program is written. In block 610, as part of the software development process, a class is defined using unified semantic rules. In block 620, the program is executed.

In one embodiment, the program is executed as part of the debugging phase of the development process. In another embodiment, the program is executed after it has been debugged. In block 630, a class-type object is instantiated by the reservation of a block on a memory heap. In block 640, constructor code is executed. The constructor code executes until the last statement has completed, as determined in block 650. In block 660, all heap memory reserved for the object is released.

Function

In one embodiment of the present invention, a function is an object that is automatically deleted after it optionally returns a value to its calling statement. In another embodiment, a function is instantiated on a memory stack. An example of a function definition in accordance with one embodiment of the present invention is as follows:

function func (arg1, arg2) {

// constructor code
// function members

}

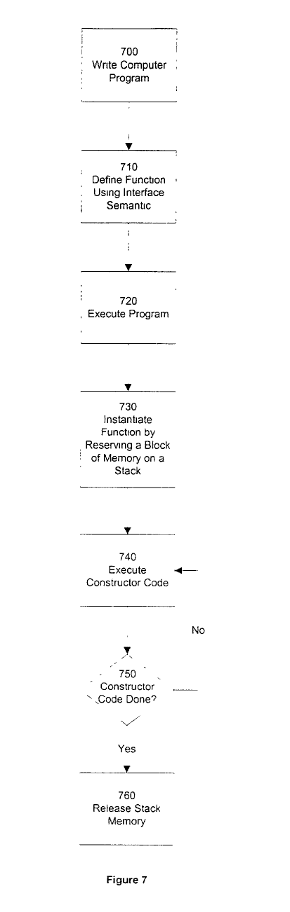

In one or more embodiments of the present invention, a function contains the same members that a class body may contain, including other functions. FIG. 7 shows an embodiment of the present invention using a unified semantic to define a function. In block 700, a computer program is written. In block 710, as part of the software development process, a function-type object is defined using unified semantics. In block 720, the program is executed.

In one embodiment, the program is executed as part of the debugging phase of the development process. In another embodiment, the program is executed after it has been debugged. In block 730, a function-type object is instantiated by the reservation of a block on a memory stack. In block 740, constructor code is executed. The constructor code executes until the last statement has completed, as determined in block 750. In block 760, all stack memory reserved for the object is released.

Embodiment of Unified Semantic Rules

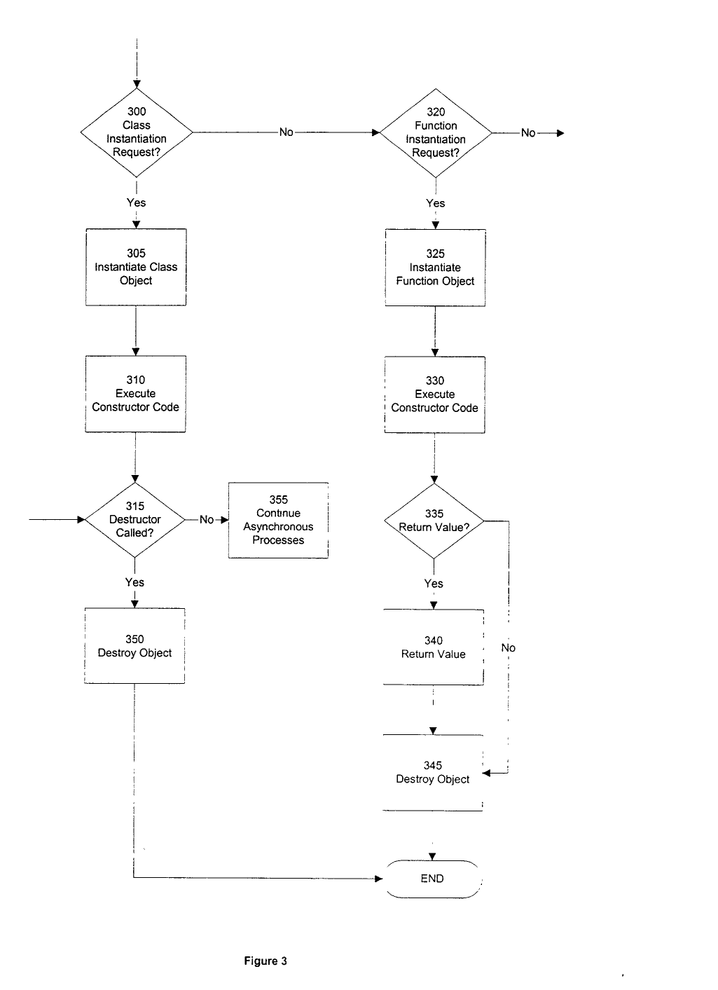

FIG. 3 illustrates an embodiment of the present invention when unified semantic rules are implemented. Decision blocks 300 and 320 determine the subject of an instantiation request. This request is any keyword whose effect is the instantiation of an object-type in the language. An example of an instantiation request in prior art languages is the new keyword in Java™ and C++. Thus, decision block 300 determines whether a class instantiation request has been made. If no, then decision block 320 determines whether a function instantiation request has been made. If no, then a line of inquiry continues until the instantiation request possibilities have been exhausted.

If the result of decision block 300 is positive, then in block 305, the class-type object is instantiated. Instantiation block 305 comprises the reservation of a memory block on the operating system heap, as well as tasks inherent in the creation of objects and well known to those of skill in the art. In block 310, any constructor code in the object is executed. In one embodiment, constructor code is a series of statements within the class body.

Decision block 315 determines whether a destructor for the object has been called. Block 315 is asynchonous with respect to the other blocks in that the destructor of an object is called at any point in time after the object is instantiated. If the result of block 315 is negative, then in block 355 the program continues asynchronous processing. If the result of block 320 is positive, then in block 350 the object is destroyed. In one embodiment, destruction block 350 decrements an object counter each time the destructor is called until the counter reaches 0. At this point, the reserved memory is freed and the object is deleted. In another embodiment, the memory is immediately freed and the object deleted.

Returning to block 320, a function-type object is instantiated in block 325 as a result of a positive determination. Instantiation block 325 comprises the reservation of a memory block on the operating system stack, as well as tasks inherent in the creation of objects and well known to those of skill in the art. In block 330, the constructor code of the function-type object is executed. The constructor code is a series of statements within the body of the function.

Decision block 335 determines whether the function returns a value. If so, then in block 340, a value is returned to the function calling point. At this point the function-type object is automatically destroyed in block 345. Block 345 is also executed directly after block 335 if the determination of block 335 is negative. The destruction of the function-type object comprises the release of memory reserved for the object.

Embodiment of Computer Execution Environment (Hardware)

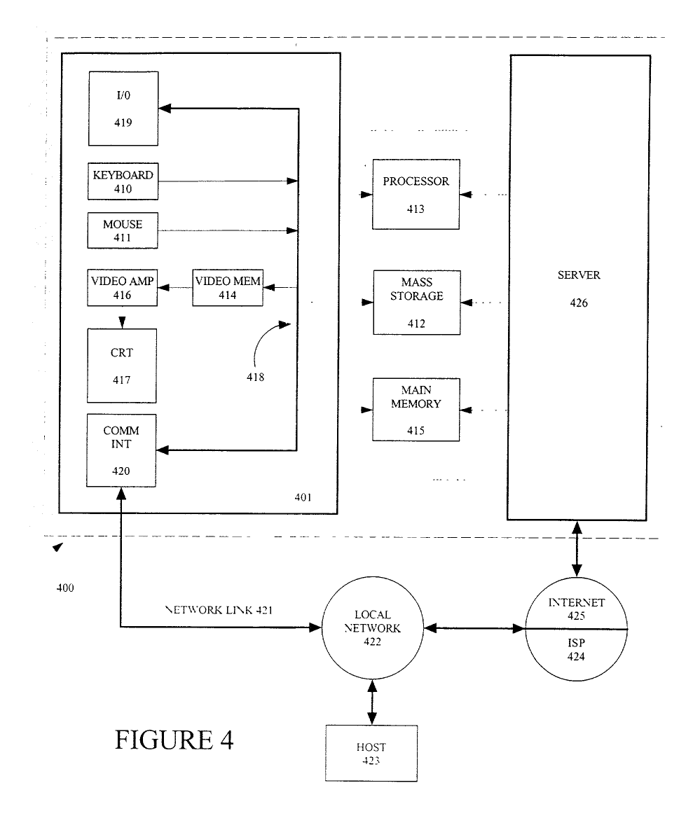

An embodiment of the invention can be implemented as computer software in the form of computer readable program code executed in a general purpose computing environment such as environment 400 illustrated in FIG. 4, or in the form of bytecode class files executable within a Java™ run time environment running in such an environment, or in the form of bytecodes running on a processor (or devices enabled to process bytecodes) existing in a distributed environment (e.g., one or more processors on a network). A keyboard 410 and mouse 411 are coupled to a system bus 418. The keyboard and mouse are for introducing user input to the computer system and communicating that user input to central processing unit (CPU) 413. Other suitable input devices may be used in addition to, or in place of, the mouse 411 and keyboard 410. I/O (input/output) unit 419 coupled to bi-directional system bus 418 represents such I/O elements as a printer, A/N (audio/video) I/O, etc.

Computer 401 may include a communication interface 420 coupled to bus 418. Communication interface 420 provides a two-way data communication coupling via a network link 421 to a local network 422. For example, if communication interface 420 is an integrated services digital network (ISDN) card or a modem, communication interface 420 provides a data communication connection to the corresponding type of telephone line, which comprises part of network link 421. If communication interface 420 is a local area network (LAN) card, communication interface 420 provides a data communication connection via network link 421 to a compatible LAN. Wireless links are also possible. In any such implementation, communication interface 420 sends and receives electrical, electromagnetic or optical signals which carry digital data streams representing various types of information.

Network link 421 typically provides data communication through one or more networks to other data devices. For example, network link 421 may provide a connection through local network 422 to local server computer 423 or to data equipment operated by ISP 424. ISP 424 in turn provides data communication services through the world wide packet data communication network now commonly referred to as the “Internet” 425. Local network 422 and Internet 425 both use electrical, electromagnetic or optical signals which carry digital data streams. The signals through the various networks and the signals on network link 421 and through communication interface 420, which carry the digital data to and from computer 400, are exemplary forms of carrier waves transporting the information.

Processor 413 may reside wholly on client computer 401 or wholly on server 426 or processor 413 may have its computational power distributed between computer 401 and server 426. Server 426 symbolically is represented in FIG. 4 as one unit, but server 426 can also be distributed between multiple “tiers”. In one embodiment, server 426 comprises a middle and back tier where application logic executes in the middle tier and persistent data is obtained in the back tier. In the case where processor 413 resides wholly on server 426, the results of the computations performed by processor 413 are transmitted to computer 401 via Internet 425, Internet Service Provider (ISP) 424, local network 422 and communication interface 420. In this way, computer 401 is able to display the results of the computation to a user in the form of output.

Computer 401 includes a video memory 414, main memory 415 and mass storage 412, all coupled to bi-directional system bus 418 along with keyboard 410, mouse 411 and processor 413. As with processor 413, in various computing environments, main memory 415 and mass storage 412, can reside wholly on server 426 or computer 401, or they may be distributed between the two. Examples of systems where processor 413, main memory 415, and mass storage 412 are distributed between computer 401 and server 426 include the thin-client computing architecture developed by Sun Microsystems, Inc., the palm pilot computing device and other personal digital assistants, Internet ready cellular phones and other Internet computing devices, and in platform independent computing environments, such as those which utilize the Java™ technologies also developed by Sun Microsystems, Inc.

The mass storage 412 may include both fixed and removable media, such as magnetic, optical or magnetic optical storage systems or any other available mass storage technology. Bus 418 may contain, for example, thirty-two address lines for addressing video memory 414 or main memory 415. The system bus 418 also includes, for example, a 32-bit data bus for transferring data between and among the components, such as processor 413, main memory 415, video memory 414 and mass storage 412. Alternatively, multiplex data/address lines may be used instead of separate data and address lines.

In one embodiment of the invention, the processor 413 is a SPARC microprocessor from Sun Microsystems, Inc., a microprocessor manufactured by Motorola, such as the 680×0 processor, or a microprocessor manufactured by Intel, such as the 80×86 or Pentium processor. However, any other suitable microprocessor or microcomputer may be utilized. Main memory 415 is comprised of dynamic random access memory (DRAM). Video memory 414 is a dual-ported video random access memory. One port of the video memory 414 is coupled to video amplifier 416. The video amplifier 416 is used to drive the cathode ray tube (CRT) raster monitor 417. Video amplifier 416 is well known in the art and may be implemented by any suitable apparatus. This circuitry converts pixel data stored in video memory 414 to a raster signal suitable for use by monitor 417. Monitor 417 is a type of monitor suitable for displaying graphic images.

Computer 401 can send messages and receive data, including program code, through the network(s), network link 421, and communication interface 420. In the Internet example, remote server computer 426 might transmit a requested code for an application program through Internet 425, ISP 424, local network 422 and communication interface 420. The received code may be executed by processor 413 as it is received, and/or stored in mass storage 412, or other non-volatile storage for later execution. In this manner, computer 400 may obtain application code in the form of a carrier wave. Alternatively, remote server computer 426 may execute applications using processor 413, and utilize mass storage 412, and/or video memory 415. The results of the execution at server 426 are then transmitted through Internet 425, ISP 424, local network 422 and communication interface 420. In this example, computer 401 performs only input and output functions.

Application code may be embodied in any form of computer program product. A computer program product comprises a medium configured to store or transport computer readable code, or in which computer readable code may be embedded. Some examples of computer program products are CD-ROM disks, ROM cards, floppy disks, magnetic tapes, computer hard drives, servers on a network, and carrier waves.

The computer systems described above are for purposes of example only. An embodiment of the invention may be implemented in any type of computer system or programming or processing environment.

Thus, a method and apparatus for the unification of the definition of a class and a function in a dynamically typed language is described in conjunction with one or more specific embodiments. The invention is defined by the following claims and their full scope an equivalents.

We claim:

1. A method for instantiating an object, comprising:
determining an object type;
reserving a memory block on a memory structure, the size of said memory block being determined according to said object type, and said memory structure being selected according to said object type; and
creating a reference structure to said object.

2. The method of claim 1, wherein said determining comprises:
obtaining a keyword; and
identifying said keyword.

3. The method of claim 2, further comprising:
executing a set of constructor statements if said set contains at least one statement.

4. The method of claim 3, wherein said keyword identifies said object type as a class.

5. The method of claim 4, wherein said memory structure is the heap.

6. The method of claim 3, wherein said keyword identifies said object type as a function.

7. The method of claim 6, further comprising:
optionally returning a value to a calling statement;
deleting said reference structure; and
freeing said memory block.

8. The method of claim 7, wherein said memory structure is the stack.

9. A computer program product comprising:
a computer usable medium having computer readable program code embodied therein configured to instantiate an object, said computer program product comprising:
computer readable code configured to cause a computer to determine an object type;
computer readable code configured to cause a computer to reserve a memory block on a memory structure, the size of said memory block being determined according to said object type, and said memory structure being selected according to said object type; and
computer readable code configured to cause a computer to create a reference structure to said object.

10. The computer program product of claim 9, wherein said computer readable code configured to cause a computer to determine an object type further comprises:
computer readable code configured to cause a computer to obtain a keyword; and
computer readable code configured to cause a computer to identify said keyword.

11. The computer program product of claim 10, further comprising:
computer readable code configured to cause a computer to execute a set of constructor statements if said set contains at least one statement.

12. The computer program product of claim 11, wherein said keyword identifies said object type as a class.

13. The computer program product of claim 12, wherein said memory structure is the heap.

14. The computer program product of claim 11, wherein said keyword identifies said object type as a function.

15. The computer program product of claim 14, further comprising:
computer readable code configured to cause a computer to optionally return a value to a calling statement;
computer readable code configured to cause a computer to delete said reference structure; and
computer readable code configured to cause a computer to free said memory block.

16. The computer program product of claim 15, wherein said memory structure is the stack.

17. A system for instantiating an object comprising:
an interpreter configured so as to differentiate object types;
a storage allocation subsystem configured so as to reserve a storage block on a memory device, said allocation subsystem further configured to select the size of said storage block and said memory device according to said object type; and
an access control subsystem, said access control subsystem creating a reference structure for said object.

18. The system of claim 17 wherein said interpreter further comprises:
a lexical analyzer; and
a semantic parser, wherein said analyzer is configured so as to pass tokens representing keywords to said parser, and said parser is configured so as to identify said tokens.

19. The system of claim 18, further comprising:
a statement execution subsystem, said execution subsystem configured so as to automatically execute a set of constructor statements.

20. The system of claim 19, wherein said keyword identifies said object as a class.

21. The system of claim 20, wherein said memory device is the heap.

22. The system of claim 19, wherein said keyword identifies said object type as a function.

23. The system of claim 22, wherein said execution subsystem is further configured so as to:
optionally return a value to an object calling subsystem.

24. The system of claim 23, wherein said storage allocation subsystem is further configured to automatically delete said reference structure and automatically freeing said storage block after said statement execution subsystem completes the execution of said set of constructor statements and completes the optional return of a value to said object calling subsystem.

25. The system of claim 24, wherein said memory device is the stack.

26. An object instantiation component for an operating system, comprising:
an interpreter configured so as to differentiate object types;
a storage allocation subsystem configured so as to reserve a storage block on a memory device, said allocation subsystem further configured to select the size of said storage block and said memory device according to said object type; and
an access control subsystem, said access control subsystem creating a reference structure for said object.

27. The component of claim 26 wherein said interpreter further comprises:
a lexical analyzer; and
a semantic parser, wherein said analyzer is configured so as to pass tokens representing keywords to said parser, and said parser is configured so as to identify said tokens.

28. The component of claim 27, further comprising:
a statement execution subsystem, said execution subsystem configured so as to automatically execute a set of constructor statements.

29. The component of claim 28, wherein said keyword identifies said object as a class.

30. The component of claim 29, wherein said memory device is the heap.

31. The component of claim 28, wherein said keyword identifies said object type as a function.

32. The component of claim 31, wherein said execution subsystem is further configured so as to:
optionally return a value to an object calling subsystem.

33. The system of claim 32, wherein said storage allocation subsystem is further configured to automatically delete said reference structure and automatically freeing said storage block after said statement execution subsystem completes the execution of said set of constructor statements and completes the optional return of a value to said object calling subsystem.

34. The system of claim 33, wherein said memory device is the stack.
